(19) United States
(12) Patent Application Publication
(10) Pub. No.: US 2011/0164405 A1
(43) Pub. Date: Jul. 7, 2011

(54) Optical element for inducing a variation of light from a light source

(75) Inventors: Erik Boonekamp, Eindhoven (NL); René Van Der Wal, Lichtenvoorde (NL)

(73) Assignee: KONINKLIJKE PHILIPS ELECTRONICS N.V., Eindhoven (NL)

(21) Appl. No.: 13/003,903

(22) PCT Filed: Jul. 10, 2009
(86) PCT No.: PCT/IB2009/053008

§ 371 Date: Mar. 24, 2011

(30) Foreign Application Priority Data
Jul. 17, 2008 (EP) 08160616.2

(51) Int. Cl. F21V 33/00

(52) U.S. Cl. 362/101; 362/318

(57) ABSTRACT

An optical element (103) for inducing a variation of light from a light source comprising a reservoir (102) containing a flexible material (104) arranged to form a light guide (104) configured to guide light (200) incoupled into the light guide (104) within a first boundary (105) formed by an interface between the flexible material (104) and a surrounding medium (109) having a refractive index being lower than the refractive index of the flexible material, and a second boundary (107) formed by an interior surface of the reservoir; a surface exciting unit (111) being arranged to induce a time varying distortion of the interface (105) between the flexible material (104) and the surrounding medium (109), wherein the distortion enables outcoupling of light at varying angles. An advantage is that a light guide enables a more compact illumination device as the light source does not need to be arranged underneath the reservoir.

### TECHNICAL FIELD

The present invention relates to an optical element for inducing a variation of light from a light source.

### BACKGROUND OF THE INVENTION

Small point light sources such as solid state light sources are extensively used for decorative/architectural lighting applications. By making a narrow beam (in one direction) one is able to illuminate a large wall with a few luminaires. Conventionally, a dynamic effect is achieved by changing the colour balance of a LED beam formed by multiple LEDs (R, G, B, warm white, cool white). This way of illumination (sometimes referred to as “wall washing”) is highly appreciated in e.g. public spaces where people stay for a relatively short time. However, a more subtle and natural way of dynamic illumination is desired in e.g. office spaces where people stay for a long period of time.

GB 2362454A depicts a lighting apparatus which has a liquid reservoir in which ripples are generated on the surface of the liquid and which can be projected by illumination from below. The ripples may be generated by a magnetic actuator, which can be floating or submerged, and which can be moved up and down by an electromagnet, driven by a varying electrical signal. However, such a lighting apparatus tends to be rather bulky, which may be unfavourable in many situations. For example, it might be difficult to build-in such a lighting apparatus to make it harmonize with the environment in a decorative lighting application. Thus, there is a need for an improved illumination device.

### SUMMARY OF THE INVENTION

In view of the above, an object of the invention is to solve or at least reduce at least one of the problems discussed above. In particular, an object is to provide an optical element that enables varying illumination and that may enable a versatile illumination device.

According to a first aspect of the invention, there is provided an optical element for inducing a variation of light from a light source comprising a reservoir containing a flexible material arranged to form a light guide configured to guide light incoupled into the light guide within a first boundary formed by an interface between the flexible material and a surrounding medium having a refractive index being lower than the refractive index of the flexible material, and a second boundary formed by an interior surface of the reservoir. A surface exciting unit is arranged to induce a time varying distortion of the interface between the flexible material and the surrounding medium, wherein the distortion enables outcoupling of light at varying angles. Through the arrangement a variation in time and space can be induced in the light output by the optical element.

The light can be guided by means of Total Internal Reflection (TIR) at the first boundary (i.e. the interface between the flexible material and the surrounding medium) and by TIR or by reflection at the second boundary.

An advantage is that an optical element comprising a light guide enables a more compact illumination device as a light source does not need to be arranged underneath the reservoir. Furthermore, it enables an illumination device where the light output is not necessarily a function of position of the light source, and thus is less sensitive to the number of light sources used and their positioning. This is particularly useful when high-power LEDs are used as the number of light sources typically is reduced in this case. Furthermore, compared to a device which uses a light source to reflect light on a liquid surface (i.e. the same principle as sunlight reflected on a water surface), guiding the light through the liquid volume is more effective and enables a more compact device as it does not depend on grazing incident light on the liquid surface.

A flexible material here should be interpreted broadly and may be any material where the surface can be e.g. elastically distorted. For instance, it may be a liquid, wherein the distortion is a ripple induced in the liquid surface. However, the flexible material may also be a solid material that is elastic or viscoelastic such as a gel or a polymer. An example would be PDMS (Polydimethylsiloxane) which is a silicon-based organic polymer.

A surface exciting unit should be interpreted broadly and may be any device usable to distort the surface of the flexible material. For a liquid surface this can be achieved for example by dipping a mechanical element into the liquid, by actuating an element floating or submerged in the liquid (e.g. by means of an electromagnetic field), by sending a pressure wave at the surface (e.g. acoustic noise from a loudspeaker or by blowing air), or by dripping or injecting a fluid into the surface. It is recognized by a person skilled in the art that similar techniques can be used also to distort flexible materials other than liquids.

The present invention is based on the understanding that if an appropriate surrounding medium is selected, the flexible material can be used as a light guide whereby the equilibrium intensity distribution output by the optical element can be randomly distorted by inducing “ripples” in the interface between the flexible material and the surrounding medium, thereby enabling dynamic outcoupling of light resulting in an illumination pattern that resembles the illumination achieved when sunlight is reflected on water and illuminates a wall or ceiling.

As a light beam propagates in a medium with a higher refractive index and strikes an interface to a medium with a lower refractive index, the light beam will normally be partially refracted and partially reflected. The larger the angle to the normal of the interface is, the smaller is the fraction of the light beam that is transmitted, until an angle where Total Internal Reflection (TIR) occurs and no light can pass through the interface and all light is reflected at the interface. The angle where this first occurs is known as the critical angle. The critical angle will typically depend on the refractive indices of the two mediums. Thus, by utilizing a liquid (or other flexible material) and a surrounding medium having appropriate refractive indices, light can be transported through the liquid and outcoupled throughout a large portion of the interface between the liquid and the surrounding medium. Furthermore, moving ripples may influence the outcoupling of light from the light guide and thereby the intensity distribution of the illumination that results from the optical element.

The flexible material may be a liquid, whereby the distortion is a ripple in the liquid surface. An advantage is that a liquid typically can generate a subtle and natural illumination pattern that e.g. resembles sunlight reflected on a water surface.

The first and second boundaries of the light guide may be arranged to form a wedge-shaped light guide. By using a wedge-shaped light guide which is tapered in a direction away from the light source, light can be outcoupled without requiring an outcoupling structure. Furthermore, the direction and beam width of the intensity distribution that escapes from the light-guide can be tuned by the relative inclination between the first and second boundaries. For a “sharp” wedge-shaped light guide, (i.e. a small relative inclination between the boundaries) the intensity distribution of the outcoupled light tend to be more narrow, but also more asymmetric. Asymmetric here means that the intensity distribution is tilted relative a normal to the interface between the flexible material and the surrounding medium. A redirecting plate may be arranged to redirect light outcoupled from the light guide in a desired direction. This enables the intensity profile of the outcoupled light to be tilted and/or shaped. The redirecting plate may be a prismatic plate provided with an appropriate prismatic structure. The prismatic structure can comprise a set of pointed prisms on a side facing the light guide. The prisms are typically regularly arranged whereas the top angle of the prisms are configured to obtain a desired light intensity profile. According to an embodiment all top angles may be the same. The prismatic plate is preferable for shaping and redirecting light intensity distribution of a wedge-shaped light guide. However, alternative redirecting plates may be used, such as, for example, a light collimating panel, or holographic foils.

The reservoir may be provided with a lid resulting in a closed reservoir. This enables a more robust illumination device, where the liquid is not spilled out, is not vaporized and/or does not comes in contact with any person.

An interior surface of the reservoir (such as, for example, the surface that constitutes the second boundary) may be a specular reflector, such as a mirror. As no light passes through the specular reflector, the amount of light that is lost (i.e. that is emitted from the device in a direction other than the intended) can be reduced, and a more efficient illumination is achieved.

The reservoir may further contain a fluid arranged at the surface of the flexible material constituting the light guide, wherein the fluid constitutes the surrounding medium. The fluid may be a gas or a liquid.

The fluid constituting the surrounding medium may be a liquid and can preferably be immiscible with the liquid constituting the light guide. By immiscible should be understood that the two liquids are arranged in and stay in two separate layers also when ripples are introduced. Furthermore, the liquid constituting the light guide may have a lower density than the liquid of the surrounding medium to enable a “down-light”. As the liquid of the light guide has a lower density than the surrounding medium, the surface of the liquid constituting the light guide will be at the underside of the light guide, whereby the induced ripples will outcouple light downwards.

The frequency may preferably be between 0.01 Hz and 10 Hz, and more preferable about 0.1 Hz. Distorting the surface with these frequencies generates moving ripples that strongly influence the intensity distribution of the outcoupled light and creates an illumination pattern that resembles light reflected on a water surface. It would also be possible to utilize a varying excitation frequency to achieve alternative illumination dynamics. The excitation may e.g. occur randomly.

The optical element may comprise multiple surface exciting units to induce distortions in the interface between the flexible material and the surrounding medium at more than one position. This enables interfering ripples in the liquid, thereby providing alternative illumination dynamics.

The surface exciting unit may preferably be arranged close to an incoupling side of the light guide. An advantage is that, as little or no light is outcoupled close to the incoupling side of the light guide, the surface exciting unit is not in the optical path. To achieve the effect the incoupling device can typically be arranged within the first fifth of the total length of the light guide.

The liquid constituting the light guide can preferably be transparent, non-flammable, non-toxic and not too volatile (i.e. has a low vapour pressure). The viscosity of the liquid is preferably chosen to enable the desired illumination dynamics. Examples of suitable liquids for use as a light guide are silicone oil and water. However, according to an embodiment the flexible material (e.g. the liquid) constituting the light guide can be coloured to achieve a desired colour of the light output by the optical element.

The optical element may be particularly useful in an illumination device which comprises a light source arranged in such a way that light emitted by the light source is coupled into the light guide of the optical element. A variety of light sources may be utilized. An example is small point light sources such as solid state light sources (e.g. light emitting diodes LEDs). Other examples of light sources are a fluorescent tube, or a laser.

The illumination device may further comprise an incoupling device, such as a collimator, that ensures that the direction of most light beams that enters the light guide is within a predetermined angle range. An advantage is that this enables an optimal illumination effect. It also enables a large portion of the light emitted from the light source to be incoupled to the light guide.

The illumination device may be used in a luminaire, e.g. a device intended to illuminate an object or a surrounding.

It is noted that the invention relates to all possible combinations of features recited in the claims.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended schematic drawings, where the same reference numerals will be used for similar elements, wherein:

FIG. 1a illustrates a perspective view of an illumination device according to the invention.

FIG. 1b is a cross-sectional view of the illumination device.

FIG. 1c is a view of three light beams as they strikes a rippled surface.

FIG. 2a illustrates a re-directing plate having a regular prismatic structure.

FIG. 2b-c illustrates how a re-directing plate may redirect the intensity distribution of outcoupled light.

FIG. 3a-b illustrates an illumination device outputting light both upwards and downwards, and a “down-light”, respectively.

FIG. 4 illustrates an alternative embodiment of a “down-light”

FIG. 5 illustrates a cylindrical illumination device.

### DETAILED DESCRIPTION OF PREFERRED EMBODIMENTS

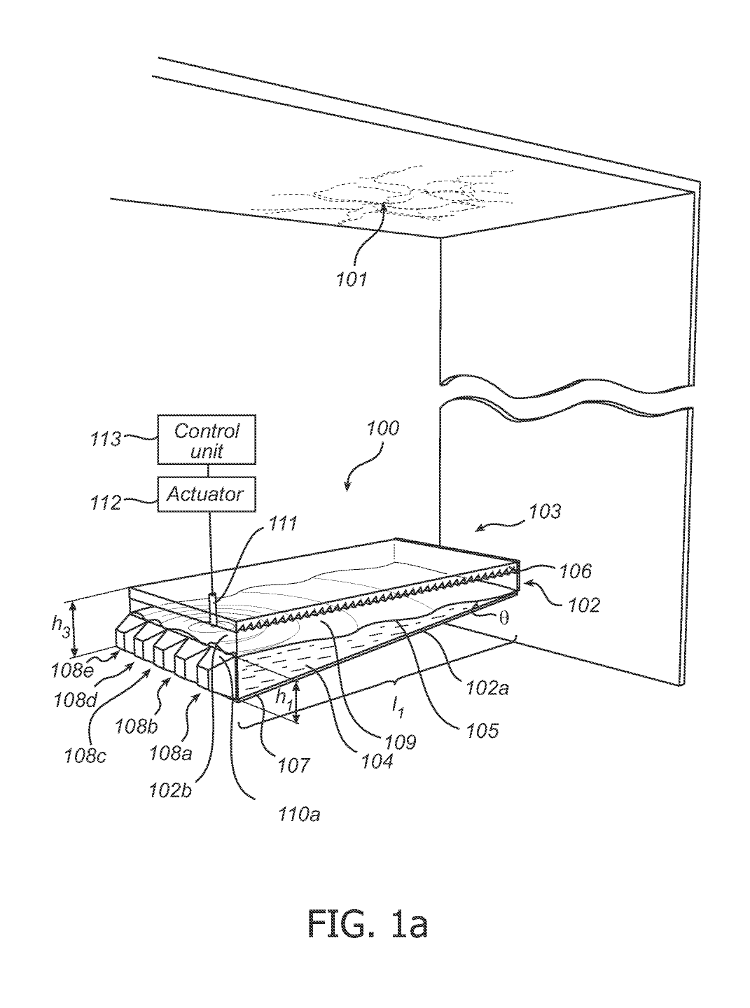

FIG. 1a illustrates an illumination device 100, which is arranged near the floor to provide dynamic illumination 101 of the ceiling. The illumination device 100 comprises an optical element 103 including a rectangular reservoir 102 containing a liquid 104 and a surrounding medium 109. The surrounding medium 109 has a refractive index which is lower than the refractive index of the liquid 104. The liquid 104 is here silicone oil having a refractive index n_{silicone}≈1.56, whereas surrounding medium 109 is air having a refractive index nₐᵢᵣ≈1.0. The illumination device 100 also comprises a plurality of light sources 108a-e are arranged along one side of the reservoir 102, hereinafter referred to as incoupling side 102b. Through the arrangement light from the light sources 108a-e can be incoupled into the liquid 104 which works as a liquid light guide 104. The size of the light emitting area of the illumination device may vary, but is typically between 0.01-0.5 m².

It is noted that the number of light sources 108a-e may vary, for example, depending on the size of illumination device 100, and for some embodiments it may suffice with a single light source. For sake of clarity, the below description will be described referring to light source 108a only. However, the same principle applies to the other light sources 108b-e.

The light source 108a may be a single LED, or an LED array comprising a plurality of LEDs. The LEDs may be, for example, R, G, B, warm white, and cool white LEDs. Furthermore, the light source 108a is provided with an incoupling structure in the form of a collimator 110a. By arranging the LED array in a collimator 110a the direction of the light beams emanating from the light source 108a can be restricted. In the illustrated embodiment the principal direction of the light source 108a is in a horizontal plane defined by the liquid surface 105, wherein the collimator is configured so that any light beam emanating from the light source 108a deviates less than ±25° degrees from the horizontal plane. It is recognized that the maximum deviation allowed may vary depending on the application as well as on the refractive indices of the liquid light guide 104 and the surrounding medium 109. For example, for a light guide having a long “sharp” wedge-shape (i.e. a smaller angle θ) the maximum deviation is typically lower.

The height of the collimator preferably corresponds to the depth, h₁, of the liquid at the incoupling side 102b, which is here about 15 mm.

The incoupling side 102b of the reservoir is essentially transparent to light emitted by the light source 108a to enable incoupling of light. Furthermore, the bottom 102a of the reservoir is provided with a flat specular reflector plate 107, for example MIRO silver from Alanod, to enable specular reflection.

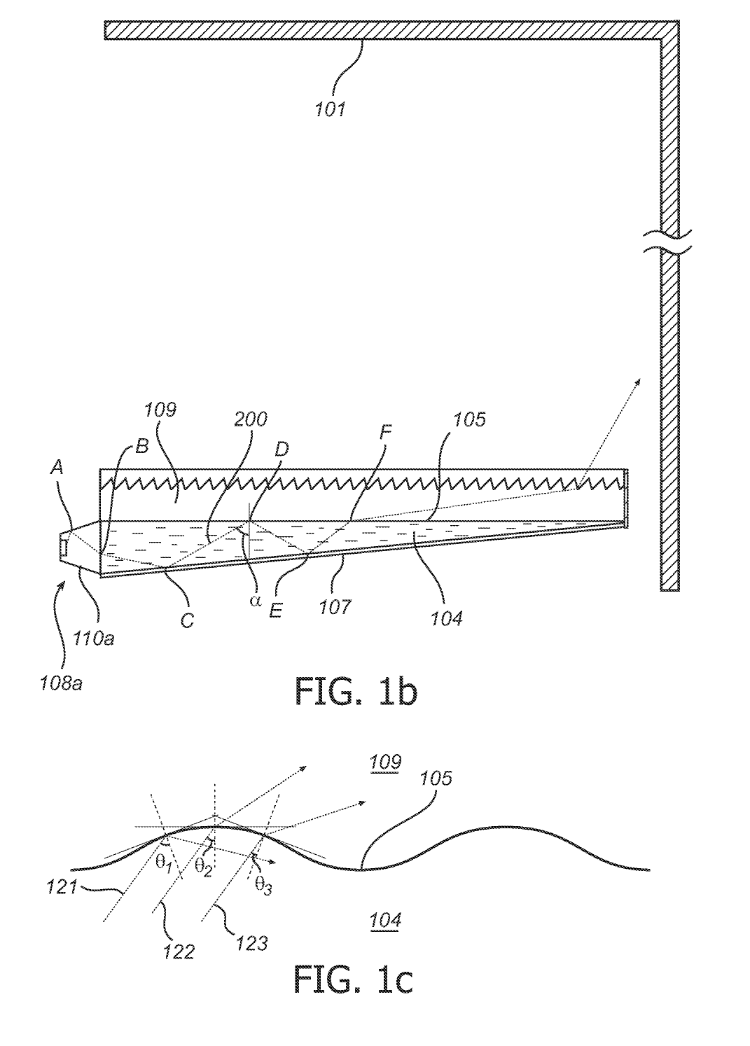

As illustrated in FIG. 1a, the bottom 102a of the reservoir is inclined to provide a tapered liquid light guide 104. The angle θ between the horizontal plane defined by the liquid surface 105 and the bottom surface 102a may vary. For a “sharp” wedge-shaped light guide, (i.e. a small θ) the intensity distribution of the outcoupled light is narrow, and asymmetric (i.e. tilted relative a normal to the liquid surface as illustrated in FIG. 2b). A preferable length/height ratio (i.e. the length of the light guide (l₁) in relation to the depth (h₁) of the liquid at the incoupling side) of a wedge-shaped light guide may be around ten.

The reservoir is here provided with a lid 106 which is arranged parallel to the liquid surface 105 and closes the reservoir completely. The surrounding medium 109 fills the space between the liquid surface 105 and the lid 106. The total height of the illumination device, h₃, is typically less than 25 mm to enable easy integration into a luminaire.

In this embodiment, the lid 106 is a re-directing plate 106 configured to redirect the outcoupled light in a desired direction. An example of a re-directing plate is illustrated in FIG. 2a. The prismatic structure is here regular, wherein each prism has a top angle γ (typically about 40°) and a pitch d being 100 μm. Furthermore, the prismatic structure is here asymmetric. As illustrated, the light beams 201,202 passing through the redirecting plate 106 are tilted towards the normal.

FIG. 2b illustrates an illumination device without a re-directing plate. It can be seen that light 203 outcoupled from the light guide 104 has an asymmetric intensity profile, meaning that the intensity profile of the emitted light is tilted relative the normal to the liquid surface. In FIG. 2c it is illustrated how the re-directing plate 106 tilts the asymmetric intensity profile towards the normal.

If the redirecting plate is omitted, an unstructured PMMA (polymethyl methaacrylate) or glass plate could alternatively be used as a lid to close the reservoir. This may be advantageous, for example, when illuminating a wall wherein an asymmetric intensity profile may be preferred.

Referring to FIG. 1a, the optical element 103 further comprises a mechanical element 111 to distort or “touch” the liquid surface and induce ripples. The mechanical element 111 is connected to an actuator 112 (such as suitable motor) that may vertically move the mechanical element 111 and dipping it into the liquid 104. The actuator 112 is connected to a control unit 113, which, via the actuator, controls the movement of the mechanical element 112. The frequency by which the surface is distorted may vary depending e.g. on the desired illumination pattern and the viscosity of the liquid, but is here about 0.1 Hz. Furthermore, by providing additional mechanical elements which touch the surface at different positions interfering waves can be generated, resulting in other illumination dynamics. These surface exciting units may or may not be synchronized. As, for a wedge-shaped light guide, essentially no light couples out in a portion of the light guide length (typically about ⅕^{th} of the total length) closest to the incoupling side 102b, the liquid surface is preferably distorted close to the incoupling side 102b where the surface exciting unit is not in the optical path.

In FIG. 1b, a light beam 200 emanating from the light source 108a is followed as it passes through the liquid light guide 104. The illustrated light beam 200 is reflected by the collimator 110a at point A before entering the liquid light guide 104 at point B. Next, at point C, the light beam is reflected by the specular reflector plate 107 at the bottom of the reservoir. Then, the light beam strikes the interface 105 between the liquid light guide 104 and the surrounding medium 109 at point D. Assuming that the angle of incidence α is larger than the critical angle (with the respect to the normal of the boundary surface) Total Internal Reflection occurs and the light is reflected and continues propagating within the liquid light guide 104. At point E the light beam is once again reflected by the specular reflector plate 107. Assuming that the light beam 200 now strikes the boundary surface 105 at point F at an angle less than the critical angle light is outcoupled. It is recognized that the number of reflections within the liquid light guide will vary for various light beams.

Through the arrangement light is transported through the liquid and outcoupled throughout the extension of the light guide. As moving ripples are introduced to the liquid surface 105 it will have a substantial influence on the outcoupling of light from the liquid light guide 104 and thus on the intensity distribution of the illumination device. The result is a dynamic light effect similar to sunlight reflected on water illuminating e.g. the ceiling of a building. The viscosity of the liquid can be chosen depending on the desired dynamic lighting effect.

FIG. 1c is a schematic view of three parallel light beams 121-123 as they strike the liquid surface 105. The first light beam 121 strikes the boundary surface at an angle θ₁ which is greater than the critical angle and is thus reflected back into the light guide 104. The second light beam strikes 122 strikes the boundary surface 105 at a point in the ripple where the tangent is horizontal. The angle of incidence θ₂ is here less than the critical angle and thus at least a fraction of the light is outcoupled. The third light beam 123 also has an angle of incidence θ₃ which is smaller than the critical angle, and thus again at least a fraction of the light is outcoupled. As θ₃<θ₂ a larger fraction of the light beam 123 will be outcoupled.

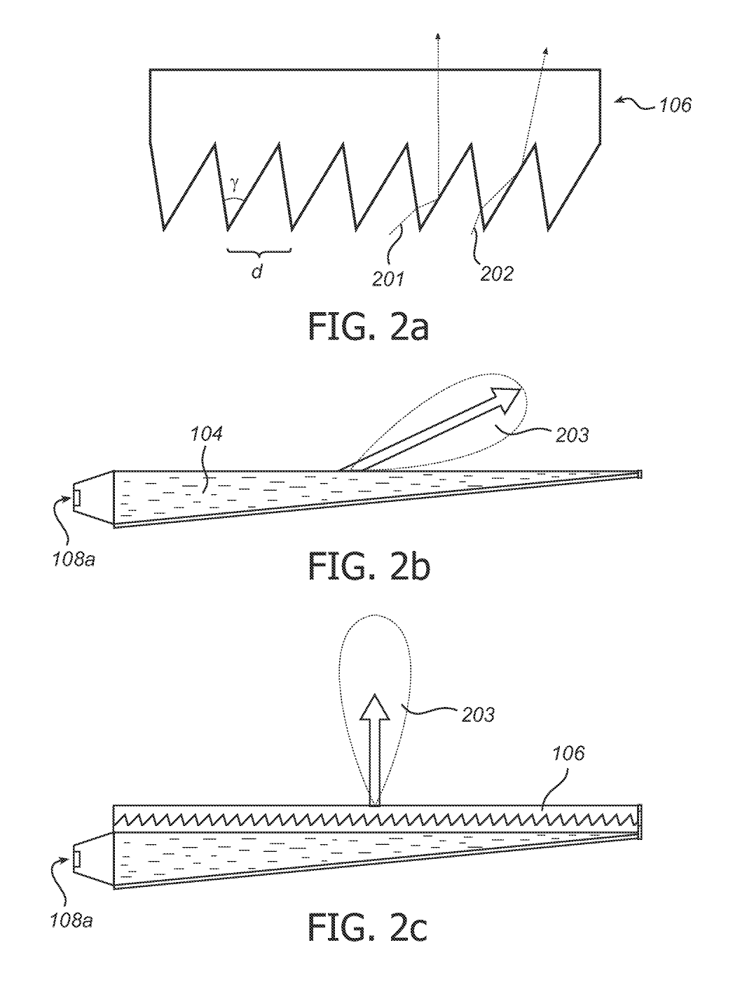

FIG. 3a illustrates an alternative illumination device where light in a liquid light guide 104 is reflected by means of Total Internal Reflection at the bottom surface (i.e. no reflective plate) and at the liquid surface 105, whereby light 304,305 can be outcoupled both upwards and downwards. Furthermore, re-directing plates 106, 302 are provided. The surrounding medium 109 can e.g. be air.

FIG. 3b illustrates an alternative embodiment where a re-directing plate 302 is arranged at the bottom of the reservoir and the lid has a specular reflective surface 301 facing the interior of the reservoir 102. This enables a “down-light” where the light 304 is emitted downwards. The light guide 104 may be a liquid and the surrounding medium 109 may be air.

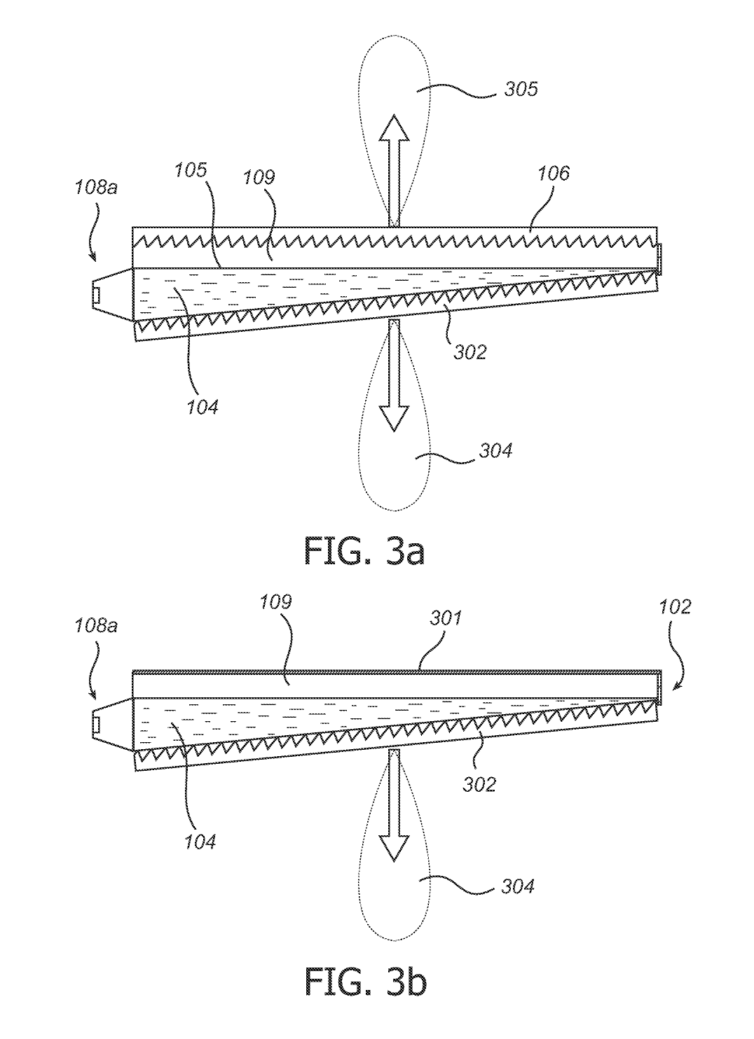

FIG. 4 illustrates an embodiment, where the surrounding medium 109 is a liquid having a lower refractive index than the liquid 104 constituting the light guide. The two liquids are here immiscible and the surrounding medium 109 has a higher density than the liquid 104 constituting the light guide, why the illumination device can be utilized as a “down-light”.

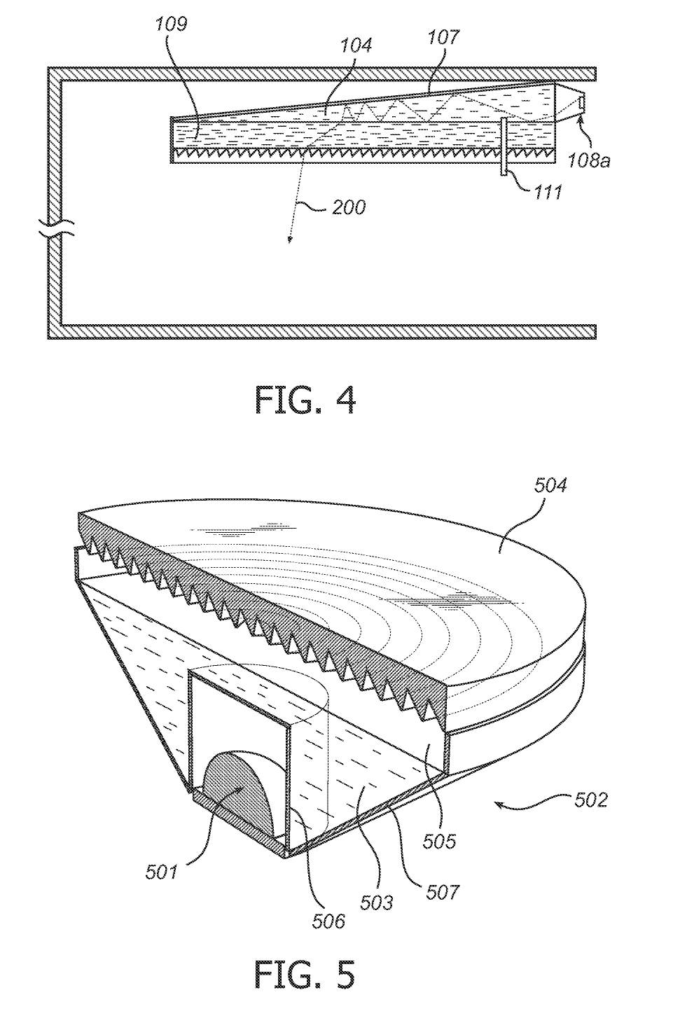

It is recognized that the shape of the illumination device may vary. For example, the illumination device may be implemented in a cylindrical system as illustrated in FIG. 5. Here, a light source 501 is arranged in the centre of a cylindrical reservoir 502. The reservoir contains a liquid 503 that forms a liquid light guide, and a surrounding medium 505 such as air. The lid is here in the form of a re-directing plate 504 having a prismatic structure in the form of concentric rings. The bottom surface 507 of the reservoir is preferably provided with a reflective surface whereas the wall 506 separating the light source 501 from the liquid is transparent to enable incoupling of light into the liquid 503. The light source 501 can preferably be provided with an incoupling structure (not shown) such as a collimator, to enable effective incoupling of light into the light guide.

The illumination device according to the invention can also illuminate a textured (rough) surface, e.g. a wall washer illuminating a textured wall. The result is that the walls change their appearance continuously because of illumination under continuously varying angles. To achieve this effect a grazing incidence is preferred.

The invention has mainly been described above with reference to a few embodiments. However, as is readily appreciated by a person skilled in the art, other embodiments than the ones disclosed above are equally possible within the scope of the invention, as defined by the appended claims. For example, the surface exciting unit may be an acoustic generator (that may distort the liquid surface by means of e.g. acoustic noise). This enables a fully closed system as no mechanical element need to be in contact with the liquid. Furthermore, ripples could be induced by blowing a gas such as air into the liquid, by dripping a liquid into the light guide surface, to actuate a magnetic element floating or submerged in the liquid by means of an electromagnetic actuator, to inject gas as bubbles blown through the liquid similar to in an aquarium, to inject a forced flow of liquid through the liquid constituting the light guide, or by external excitation of the complete device (e.g. by vibrating the complete device). It is recognized that similar arrangements could be used to distort an interface between two liquids or to distort a flexible material other than a liquid.

Also, the shape of the light guide may vary. For example, the light guide can have a rectangular cross-section instead of being wedge-shaped, or have a shape that is customized to enable a desired outcoupling of light from the light-guide. For some designs, such as a rectangular cross-section, an outcoupling structure may be required to extract light from the light guide. It is recognized by a person skilled in the art that a variety of outcoupling structures can be utilized, such as, for example, small protrusions, or scattering dots on the bottom of the reservoir (i.e. on the second boundary of the light guide).

It is recognized that the illumination device could be used to illuminate other surfaces than a wall or a ceiling. The invention may find a variety of applications such as, e.g. architectural/decorative lighting, indoor lighting, dynamic natural lighting in an office environment.

1. An optical element for inducing a variation of light from a light source, comprising:
a reservoir containing a flexible material arranged to form a light guide configured to guide light incoupled into the light guide within a first boundary formed by an interface between the flexible material and a surrounding medium having a refractive index being lower than the refractive index of the flexible material, and a second boundary formed by an interior surface of the reservoir;
a surface exciting unit being arranged to induce a time varying distortion of the interface between the flexible material and the surrounding medium, wherein the distortion enables outcoupling of light at varying angles.

2. An optical element according to claim 1, wherein said flexible material is a liquid and said distortion is a ripple in the liquid surface.

3. An optical element according to claim 1, wherein the first and second boundaries of the light guide are arranged to form a wedge-shaped light guide.

4. An optical element according to claim 1, further comprising a redirecting plate arranged to redirect light outcoupled from the light guide in a desired direction.

5. An optical element according to claim 1, wherein the reservoir is provided with a lid resulting in a closed reservoir.

6. An optical element according to claim 1, wherein an interior surface of the reservoir is a specular reflector.

7. An optical element according to claim 2, wherein the reservoir further contains a fluid arranged at a surface of the flexible material constituting the light guide, said fluid constituting said surrounding medium.

8. An optical element according to claim 7, wherein the fluid is a liquid which is immiscible with the liquid of the light guide and has a lower density.

9. An optical element according to claim 1, wherein the frequency with which the interface is distorted is between 0.01 Hz and 10 Hz.

10. An optical element according to claim 1, comprising multiple surface exciting units to induce distortions in the interface between the flexible material and the surrounding medium at multiple positions.

11. An optical element according to claim 1, wherein the surface exciting unit is arranged in proximity to a side of said light guide where light is intended to be incoupled.

12. An illumination device comprising an optical element according to claim 1 and a light source arranged in such a way that light emitted by the light source is coupled into the light guide of said optical element.

13. An illumination device according to claim 1, further comprising an incoupling device for directing the light beam to enter the light guide within a predetermined angle range.
